(19) United States
(12) Patent Application Publication
(10) Pub. No.: US 2010/0282102 A1
(43) Pub. Date: Nov. 11, 2010

(54) LABEL PRINTING CYLINDER AND PROCESS

(76) Inventor: Sharmin MEHDIZADEH, Great Neck, NY (US)

Correspondence Address: Hasse & Nesbitt LLC, 8837 Chapel Square Drive, Suite C, CINCINNATI, OH, 45249, US

(21) Appl. No.: 12/776,987

(22) Filed: May 10, 2010

Related U.S. Application Data
(60) Provisional application No. 61/215,688, filed on May 8, 2009.

(51) Int. Cl. B41F 1/46; B41F 13/10

(52) U.S. Cl. 101/363; 101/375; 101/483

(57) ABSTRACT

A printing cylinder for printing at least two different designs on a continuous roll of a substrate. The printing cylinder has at least one printing plate secured to the surface of the cylinder, and each printing plate prints a different design. The substrate comprises vinyl, PVP, cellophane, wood pulp, or paper. The printing cylinder typically has at least two printing plates, that occupy the same arc or different arcs of the circumference of the printing cylinder. Also disclosed is a printing station comprising the printing cylinder, and a process for printing at least two different designs on a continuous roll of a substrate using the printing cylinder.

### CROSS-REFERENCE TO RELATED APPLICATIONS

This application claims the benefit of co-pending U.S. Provisional Application No. 61/215,688, filed May 8, 2009.

### FIELD OF THE INVENTION

The present invention relates to a label printing cylinder, system and method for printing alternating or multiple different designs on a substrate, such as a continuous roll of substrate. More particularly, the present invention is directed to an improved printing cylinder and system for printing alternating designs on a substrate so that multiple designs can be generated in a single run through a printing system.

### BACKGROUND OF THE INVENTION

There are a number of different printing processes available for printing on a substrate. The substrate may be an individual sheet or a roll or other form of any suitable material. One common printing method for packaging materials is a flexographic printing process. Flexographic printing processes are frequently used to print a variety of materials, including but not limited to packaging, corrugated containers, folding cartons, multiwall sacks, paper sacks, plastic bags, milk and beverage cartons, disposable cups and containers, labels, adhesive tapes, envelopes, newspapers and wrappers. One common flexographic printing process is the four color printing process.

In the flexographic printing process there is a station with four rollers. There is a first cylindrical roller that has a surface that contacts ink in an ink pan so that a portion of the cylindrical roller's outer surface contacts the ink. As the first cylindrical roller rotates, ink in the ink pan coats the outer surface of the roller. The ink on the surface of the first cylindrical roller is transferred from the first roller to a second roller, such as an anilox roller. The anilox roller rotates and contacts a third roller, such as a printing cylinder that has a printing plate on its surface. As the anilox roller rotates, ink on its surface is transferred from the anilox roller to the printing cylinder. The printing cylinder has a printing plate secured to its surface. Ink from the anilox roller contacts the printing plate transferring the ink to the surface of the printing plate. As the printing cylinder and printing plate rotate, the substrate which is being printed on passes between the printing cylinder and a fourth roller called an impression cylinder. Ink on the printing plate contacts the substrate as it passes between the printing cylinder and the impression cylinder. The ink is transferred to the substrate to produce the desired impression thereon.

A station with four rollers or cylinders such as described above is necessary for each color that is to be used in printing on the substrate. In many applications, a four color system is used whereby there is a four roller station for each of the colors of the four color system. However, for some applications there are six color systems that would have six stations.

The printing plates used in the process are typically made of flexible materials, such as photopolymer rubber. The substrate that is being printed on can be any suitable material and may include, but is not limited to, vinyl, PVP, wood pulp, paper and/or cellophane.

Prior art printing methods typically were incapable of printing alternative designs except as a fill run when the run of a prior design had been completed. This would necessitate separate runs for each different feature. In the four color printing process, there are four stations where each of the four colors is applied to the substrate. Where different designs or colors are to be printed on the substrate, the traditional approach using the four color system or other printing system has been to perform a run of the substrate on the first design or color desired. This would be followed by subsequent runs for each additional design or color. The different products from each run would then have to be manually separated or combined to fill orders.

Due to the emergence of a strong system of national chains, manufacturers need their products to appeal to a variety of consumers across racial, gender and economic categories. One way to do this is through different product labeling/packaging for the same item, addressed to each individual market.

A product category in which this is prevalent is baby goods. Parents often choose products based on the sex of their child. For instance, parents of girls gravitate towards pink products when dressing their child, decorating or choosing everyday items such as diapers and wipes. Retailers have responded to this need of shoppers by requiring manufacturers of baby products to provide identical products in pink and blue packaging. In order to fulfill this demand, manufacturers are absorbing extra cost in the printing of labels/packaging, labor and manufacturing of the goods. Since there are separate runs for each color or other theme in the package, in order to ship the products in a container having equal or pre-selected amounts of each theme, the products of one run must be combined with the products of a second or additional run in the proper quantities.

Currently, when a manufacturer wants to offer the same product with two different types of labeling/packaging, they must treat each design as a separate entity. For instance, if a manufacturer wanted to offer a baby wipe that was sealed into either a blue or a pink film pouch, there would be a first print run of one attribute, such as color, and a second print run of the other attribute. Additional runs would be performed for further attributes. For pink and blue wipes, the manufacturer could first produce all the wipes in the pink pouch, switch the machine over to the blue pouch, and then run the blue wipes. The problem with this method is that the end product is boxes of pink and boxes of blue pouches, when what is desired is a shipping container that contains half pink and half blue pouches. To rectify this, the manufacturer has to use physical manpower to repack the boxes with the correct ratio of blue to pink pouches. This adds to the manufacturing costs, which may or may not be able to be passed on to the purchaser.

In accordance with the present invention, the disadvantages of prior label printing methods and production, as discussed above, have been overcome. The label production system and method of the present invention allows alternating designs to be printed on a continuous roll of substrate. The system and method of the present invention also allows manufacturers of products to produce alternating designs that appeal to a wider range of the population and thus increase their sales.

### SUMMARY OF THE INVENTION

The present invention relates to a printing cylinder for printing at least two different designs on a continuous roll of a substrate, the printing cylinder having at least one printing plate secured to the surface of the cylinder, wherein the cylinder is capable of printing at least two different designs on a continuous roll of a substrate.

The invention also relates to a printing station comprising (1) an ink reservoir for holding a quantity of ink, (2) a first roller having a surface that contacts the ink when the roller is rotated, (3) an anilox roller that receives the ink from the first roller when the anilox roller is rotated, (4) a printing cylinder that receives the ink from the anilox roller when the printing cylinder is rotated, wherein the printing cylinder has at least one printing plate secured to the surface of the cylinder and is capable of printing at least two different designs on a continuous roll of a substrate when it is rotated, and (5) an impression cylinder, wherein at least two different designs are printed on the substrate as it passes between the printing cylinder and the impression cylinder.

The invention also relates to a process for printing at least two different designs on a continuous roll of a substrate, the process using a printing cylinder having at least one printing plate secured to the surface of the cylinder, wherein the cylinder is capable of printing at least two different designs on a continuous roll of a substrate.

The invention is directed to an improved printing process. In one embodiment of the printing process there is an improved printing cylinder. The improved printing cylinder may have two or more impressions on the printing plate to permit two or more different designs to be printed on a single roll of substrate. Using this embodiment, there may be a series of individual print stations, one for each design or color to be printed on a substrate. Where alternate designs are to be printed, one printing plate would provide an impression at a station and another printing plate would not. At a second or additional print station, the other color or design would be added and the second printing plate would provide the impression to the substrate and the first would not.

In another embodiment, each printing plate on the printing cylinder may be on the circumference in such a manner that each is the same distance from the end of the printing cylinder as the other. In this embodiment, the printing plates are aligned such that they are on the outer circumference of the printing cylinder, each one being the same distance from the end of the cylinder as the other. The only difference in the arrangement of the printing plates is that each one occupies a different arc of the circumference than the other. The printing cylinder may have two or more printing plates as desired, each one taking up a portion of the arc of the circumference.

In a still further embodiment, the printing plates can be in a side by side relationship on the printing cylinder, i.e. when the first printing plate and the second subsequent printing plate are positioned on the circumference of the printing cylinder, one printing plate is further away from one end of the printing cylinder than the other printing plate. In this embodiment, there is a series of stations. At one station, one of the printing plates is used to print on the substrate. At a second station, the other of the printing plates is used to print on a different location on the substrate.

The invention provides a flexible printing system that enables a printer to vary the print products produced during a single run. The invention also provides an improved printing plate for printing multiple colors. In one embodiment, the invention provides a unique printing system for printing labels and the like. In another embodiment, the invention provides a method and apparatus for printing two or more groups of colors on a label so that the individual products do not need to be sorted. For example, one may print pink and blue themed products during a single run so that the products are present in equal amounts after the printing run, or produce multiple variations of a printed package on a single line.

### BRIEF DESCRIPTION OF THE DRAWINGS

FIG. 1 is a perspective view of a printing cylinder of the invention having a printing plate thereon.

FIG. 2 is a side view of a printing station of the invention.

FIG. 3 is a perspective view of another printing cylinder of the invention having two printing plates thereon.

### DETAILED DESCRIPTION OF THE INVENTION

The present invention is directed to a system of printing a continuous roll of a substrate material. The substrate may be comprised of, but is not limited to, vinyl, PVP, cellophane, wood pulp, or paper. The substrate is printed with two or more different designs, for example alternating designs or multiple different designs.

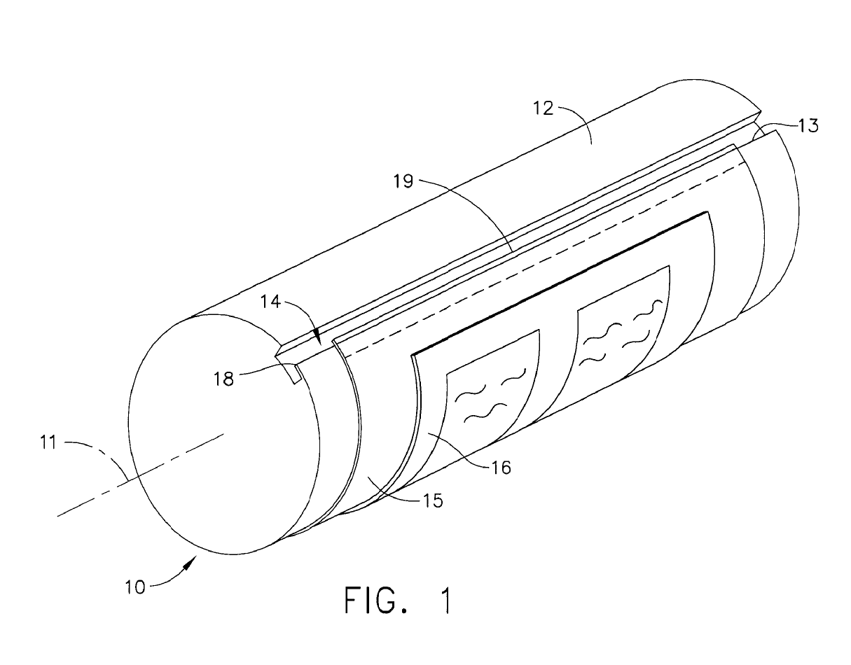

Referring to FIG. 1, a printing cylinder 10 is shown having a longitudinal axis 11, a peripheral outside surface 12, and a slot 13 having an opening 14 which is substantially flush with the peripheral surface 12 of the cylinder 10. The peripheral outside surface 12 includes an extending member 18 which extends into the opening 14 and over a portion of the slot 13. The extending member 18 is substantially flush with the peripheral outside surface 12 of the cylinder 10. The slot 13 is parallel to the longitudinal axis 11 of the cylinder 10. A printing plate 16 is securely mounted via a carrier sheet 15 to the printing cylinder 10. Unlike other printing techniques in the corrugated printing industry, the printing cylinder 10 is designed with the slot 13 so that a mounting bar 19 can remain in position and secure the carrier sheet 15 and the printing plate 16 to the cylinder 10 during the printing process. In one embodiment, the mounting bar 19 secures the leading end of the carrier sheet 15 to a portion of the extending member 18 beneath it. The mounting bar may have a longitudinally extending slot that allows it to be clipped over the leading end of the carrier sheet and the extending member. Alternatively, various fasteners may be used to secure the mounting bar to the carrier sheet and the extending member. The trailing end of the carrier sheet 15 may be secured to the printing cylinder 10 by conventional means such as tape or strap like devices. Other means for mounting the printing plate or plates to the printing cylinder may be used.

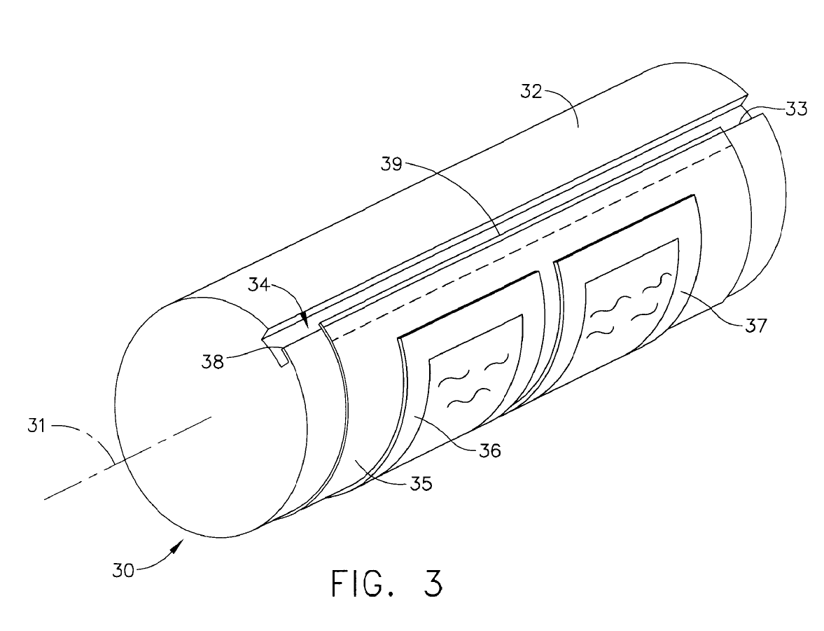

FIG. 3 illustrates another printing cylinder 30 of the invention having a longitudinal axis 31, a peripheral outside surface 32, and a slot 33 having an opening 34 which is substantially flush with the peripheral surface of the cylinder. The peripheral outside surface includes an extending member 38 which extends into the opening 34 and over a portion of the slot 33. The extending member is substantially flush with the peripheral outside surface of the cylinder. The slot is parallel to the longitudinal axis of the cylinder. A first printing plate 36 and a second printing plate 37 are securely mounted via a carrier sheet 35 to the printing cylinder. A mounting bar 39 secures the leading end of the carrier sheet to a portion of the extending member beneath it, and thus secures the carrier sheet and the printing plates to the cylinder during the printing process. The trailing end of the carrier sheet is secured to the printing cylinder by conventional means such as tape or strap like devices.

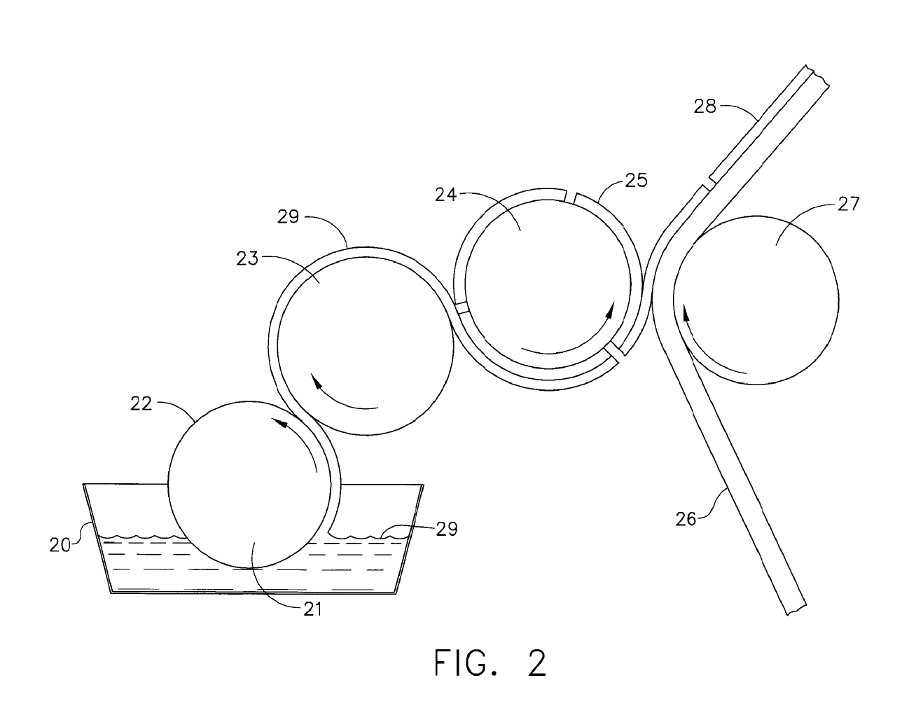

As described above, a printing plate may have a pair of images in a side by side relationship or two or more printing plates may have images in a side by side relationship. In one embodiment, such as shown in FIG. 1, the images are adjacent to each other on one printing plate on the printing cylinder and occupy the same arc of the circumference of the printing cylinder. In another embodiment, such as shown in FIG. 3, one lateral side edge of a first printing plate is proximate one end of the printing cylinder and the opposite lateral side edge of the printing plate is adjacent to a second printing plate. The second printing plate has a first lateral side edge adjacent to the first printing plate and a second lateral side edge proximate the opposite end of the printing cylinder. In an alternative embodiment, two or more different printing plates occupy different arcs of the circumference of the printing cylinder and the lateral side edges of the first printing plate are generally the same distance from the ends of the cylinder as the corresponding lateral side edges of the second printing plate or additional printing plates. For example, in FIG. 2 three printing plates 25 occupy different arcs of the circumference of printing cylinder 24. The lateral side edges of one printing plate are generally the same distance from the ends of the cylinder as the corresponding lateral side edges of the other printing plates.

In a first embodiment of the present invention, there is a system for offset lithography. In this first embodiment, there are a plurality of stations depending on the number of colors of ink that are being applied to a substrate. There may be one or more stations. Typically, there are four stations, although in some applications there may be five or six stations.

In one embodiment, each station, as seen in FIG. 2, has four rollers. There is an ink pan or reservoir 20 that holds a quantity of a given color of ink 29. A first roller 21 is rotated so that a portion of its surface 22 contacts the ink. The first roller is typically denominated the fountain roller. The ink that coats the surface 22 of the first roller 21 is transferred to an anilox roller 23. As the anilox roller 23 rotates, ink is transferred to the printing cylinder 24 that supports printing plates 25. The substrate 26 that is being printed on passes between the printing cylinder 24 and the impression cylinder 27. As the printing cylinder 24 rotates, the ink is passed onto the substrate 26 forming an impression 28 thereon. The printing plates continue rotating back to the anilox roller 23 where the ink supply is renewed for further printing. In one arrangement, there is a series of rollers such as has been described for each color or each different design to be applied to the substrate. The colors in the four color process are cyan, magenta, yellow and black. When a six color process is used, orange and green are added to the traditional cyan, magenta, yellow and black.

During the process, the anilox roller applies a uniform layer of fast drying ink to the raised portion of each printing plate. The printing plate is then rotated until it comes into contact with the substrate, for example a film, to which the image is transferred. When multiple colors are printed or images have to be superimposed, the various colors or images are added sequentially via multiple runs through stations of the printing press. To produce a quality product, printing plates have to be synchronized so that the colors or images are accurately created.

The location of the printing plate is critical to the accurate production of the design. The printing machine can include a printing head having an adequate support surface and a holding means for securing the printing plate to the support surface. The printing plate is also mounted on a printing cylinder that allows the design to be impressed on the substrate as the cylinder rotates. The printing plates can be mounted to the printing cylinder by any suitable means that affixes them firmly in place. Some methods include using a carrier sheet that wraps around at least a portion of the printing cylinder and has one or more printing plates attached to it, or directly mounting the plates onto the printing cylinder.

When the user desires to print alternating designs on a substrate, in one embodiment, such as shown in FIG. 2, the system uses a printing cylinder with a first printing plate at a first location on the circumference of the printing cylinder and a second printing plate on a second location on the circumference. The first printing plate covers a portion of the arc of the circumference. One lateral side edge of the printing plate is a first distance from one end of the printing cylinder. The opposite lateral side edge of the printing plate is a second distance from the opposite end of the printing cylinder. The second printing plate has a first lateral side edge the same distance from the end of the printing cylinder as the first printing plate and a second opposite lateral side edge the same distance from the second, opposite end of the print cylinder. The printing plates are in an end to end relationship.

A second embodiment, such as shown in FIG. 3, includes one printing cylinder with two different printing plates. One printing plate is positioned on the circumference of the cylinder where one lateral side edge of the printing plate is closer to one end of the cylinder than the other lateral side edge of the printing plate is to the opposite end of the cylinder. The other printing plate is adjacent to the first printing plate on the same cylinder, in a side by side relationship. In both embodiments, the first printing plate prints the first design or color followed by the second printing plate which prints a second design or color. When the first design or color is being printed, the first printing plate receives ink and the second plate does not. When the second color is printing, the opposite occurs. The second printing plate receives ink and the first printing plate does not receive ink. Subsequently, colors can be added by additional roller stations with printing plates provided that subsequent printing plates are aligned with the printing plates on the first run. The invention thus provides the ability to print alternative designs and colors on a single roll of substrate material in either the longitudinal (machine) direction or the lateral (transverse or cross) direction, or both.

In an alternate embodiment of the present invention, there is a first printing plate attached to a first cylinder. There are subsequent printing plates attached to subsequent cylinders for each additional color or design feature being used. At least one of the printing cylinders has two printing plates on the cylinder. At least one of the printing plates may be, for example, for the color blue. The other printing plate may be for the color pink where, for example, the products are being printed for boys and girls. It will be appreciated that other color combinations can be used depending on what product labels are being printed. When blue is being printed, one of the printing plates on the cylinder applies blue ink and the pink plate receives no ink. In the instance where pink is being printed, the pink printing plate receives the pink ink and the blue printing plate receives no ink. As noted above, subsequent cylinders may have a single plate for applying subsequent colors to the label. These printing plates must be adjusted so that the printing plates for the subsequent colors are aligned with the blue or pink printing plates.

In a still further embodiment of the present invention, subsequent printing cylinders have dual printing plates so that the different colors or designs can be printed based on the impression that is desired. Each of the cylinders has a pair of printing plates attached to it. On one of the cylinders there is a printing plate for printing the first design and a second printing plate for printing a second design. Each subsequent cylinder also has two printing plates. In this manner, two different labels may be printed simultaneously so that at the end of the run there are equal amounts of labels containing two different designs.

In a still further embodiment, there exists a line of printing cylinder stations. The first cylinder station applies a first color to alternative portions of a substrate and the second cylinder station is for applying a second color to the portions of the substrate that did not receive the first color or design. There are subsequent printing cylinders for each additional color or design to be added to the substrate.

Thus, in one aspect of this embodiment there is a printing cylinder station to apply a blue ink, a second station to apply a pink ink, and one or more subsequent cylinder stations for applying additional colors. In this embodiment, the substrate is a film of any suitable printing material, such as paper, plastic, etc. The substrate passes through the first cylinder with a single printing plate, forming a first impression. The blue ink is applied. The second cylinder with a printing plate for applying pink ink does not apply ink to the first impression but subsequent cylinders with their printing plates apply whatever additional colors are called for, if any, to the first impression. The second impression to be made does not have any blue ink applied but it does have pink ink. The pink ink is applied by the second cylinder forming the second impression. The subsequent colors are added as called for. In this embodiment, the third, fifth and subsequent odd numbered impressions can be made in the same manner thereby forming additional blue labels on the substrate. Similarly, the fourth, sixth and subsequent even numbered impressions can be pink. Once the roll is printed up, the labels can be applied to the packaging by any suitable means. In applying these labels to the packaging there are alternate color combinations and generally equal amounts of each color scheme, blue and pink. While this embodiment is shown with the odd impressions being blue, and the even ones being pink, a computerized system may alter the arrangement to the opposite or even one where the impressions are created with three or four or more different color schemes, e.g., blue, pink, orange, and yellow. Also, a computer system may alter which impressions in the run are provided with which color. For example, impressions 1, 2, 7, 8, 11, and 12 may be blue and 3, 4, 5, 6, 9, and 10 may be pink. Other combinations may be desired.

Each of the different or alternating impressions on the substrate may separated from adjacent impressions by a mark on the substrate, for example, by an eye mark, at the center, end or other predetermined point on the impression. The location of the mark may determined by a sensor that is in communication with a devise that cuts, separates and/or applies each label to the packaging prior to packing and shipping the finished products to customers.

Although the present invention has been described with respect to specific embodiments and examples, various modifications will be apparent from the present disclosure and are intended to be within the scope of the following claims.

What is claimed is:

1. A printing cylinder for printing at least two different designs on a continuous roll of a substrate, the printing cylinder having at least one printing plate secured to the surface of the cylinder, wherein the cylinder is capable of printing at least two different designs on a continuous roll of a substrate.

2. The printing cylinder of claim 1 having at least two printing plates secured to the surface of the cylinder, wherein each printing plate prints a different design.

3. The printing cylinder of claim 1 wherein the substrate comprises vinyl, PVP, cellophane, wood pulp, or paper.

4. The printing cylinder of claim 1 wherein the designs alternate between a first color and a second color.

5. The printing cylinder of claim 1 having at least two printing plates that occupy the same arc of the circumference of the printing cylinder.

6. The printing cylinder of claim 1 having at least two printing plates that occupy different arcs of the circumference of the printing cylinder.

7. The printing cylinder of claim 1 wherein the at least one printing plate is secured to the surface of the cylinder using at least one carrier sheet.

8. The printing cylinder of claim 7 having a longitudinal axis, a peripheral outside surface, a longitudinally extending slot having an opening which is substantially flush with the peripheral outside surface, and an extending member that extends into the opening and over a portion of the slot, the extending member being substantially flush with the peripheral outside surface.

9. The printing cylinder of claim 8 having a mounting bar that secures the carrier sheet to the extending member on the peripheral outside surface of the cylinder.

10. A printing station comprising (1) an ink reservoir for holding a quantity of ink, (2) a first roller having a surface that contacts the ink when the roller is rotated, (3) an anilox roller that receives the ink from the first roller when the anilox roller is rotated, (4) a printing cylinder that receives the ink from the anilox roller when the printing cylinder is rotated, wherein the printing cylinder has at least one printing plate secured to the surface of the cylinder and is capable of printing at least two different designs on a continuous roll of a substrate when it is rotated, and (5) an impression cylinder, wherein at least two different designs are printed on the substrate as it passes between the printing cylinder and the impression cylinder.

11. The printing station of claim 10 wherein the printing cylinder has at least two printing plates secured to the surface of the cylinder and each printing plate prints a different design.

12. The printing station of claim 10 wherein the substrate comprises vinyl, PVP, cellophane, wood pulp, or paper.

13. The printing station of claim 10 wherein the designs alternate between a first color and a second color.

14. The printing station of claim 10 wherein the printing cylinder has at least two printing plates that occupy the same arc of the circumference of the printing cylinder.

15. The printing station of claim 10 wherein the printing cylinder has at least two printing plates that occupy different arcs of the circumference of the printing cylinder.

16. A printing system comprising the printing station of claim 10 for printing each of the four colors cyan, magenta, yellow and black.

17. A printing system comprising the printing station of claim 10 for printing each of the six colors cyan, magenta, yellow, black, orange and green.

18. A process for printing at least two different designs on a continuous roll of a substrate, the process using a printing cylinder having at least one printing plate secured to the surface of the cylinder, wherein the cylinder is capable of printing at least two different designs on a continuous roll of a substrate.

19. The process of claim 18 wherein the printing cylinder has at least two printing plates secured to the surface of the cylinder and each printing plate prints a different design.

20. The process of claim 19 wherein the designs alternate between a first color and a second color.
